(19) United States
(12) Patent Application Publication
(10) Pub. No.: US 2006/0041689 A1
(43) Pub. Date: Feb. 23, 2006

(54) Data transfer control system, electronic apparatus and program

(76) Inventors: Shinichiro Fujita, Kitakyushu (JP); Hiroyuki Kanai, Shiojiri (JP); Koji Nakao, Matsumoto (JP); Hiroshi Yakushiji, Kitakyushu (JP)

Correspondence Address: HARNESS, DICKEY & PIERCE, P.L.C., P.O. BOX 828, BLOOMFIELD HILLS, MI, 48303, US

(21) Appl. No.: 11/186,079

(22) Filed: Jul. 21, 2005

(30) Foreign Application Priority Data
Aug. 18, 2004 (JP) 2004-238695

(51) Int. Cl. G06F 13/10

(52) U.S. Cl. 710/2

(57) ABSTRACT

A data transfer control system for controlling data transfer between a first electronic apparatus coupled to a first bus and a device coupled to a second bus including a coupling control unit that issues an instruction to execute attachment to the first bus before power supply to the device is turned on, a bus state monitoring unit that detects whether or not the first bus enters a reset state after attachment and a power supply control unit that implements power supply control to turn on power supply to the device if a reset state of the first bus is detected.

### BACKGROUND OF THE INVENTION

1. Technical Field

The present invention relates to a data transfer control system, an electronic apparatus and a program.

2. Related Art

In recent years, high-speed serial interfaces such as USB 2.0 and IEEE1394 have been highlighted. Various related arts have been disclosed to save power of electronic apparatuses incorporating a data transfer control system for achieving such high-speed serial interfaces. For example, Japanese Unexamined Patent Publications No. 11-212681 and No. 2001-195158 are examples of related art.

In the methods of related art, however, a power supply of a device in an electronic apparatus is turned on even when the electronic apparatus is coupled via a USB cable to a personal computer (PC) in a standby state, for example, resulting in insufficient power saving.

### SUMMARY

An advantage of the invention is to provide a data transfer control system, an electronic apparatus and a program that achieve power supply control providing high efficiency of power saving.

An aspect of the invention relates to a data transfer control system for controlling data transfer between a first electronic apparatus coupled to a first bus and a device coupled to a second bus. The data transfer control system includes a coupling control unit that issues an instruction to execute attachment to the first bus before power supply to the device is turned on, a bus state monitoring unit that detects whether or not the first bus enters a reset state after attachment, and a power supply control unit that implements power supply control to turn on power supply to the device if a reset state of the first bus is detected.

In the aspect of the invention, attachment to the first bus (first electronic apparatus) is executed before power supply to the device is turned on. Then, after the attachment, power supply to the device is turned on, on condition that the reset state of the first bus is detected. According to this operation sequence, if the first electronic apparatus (host system) is in a normal operation state or the like, for example, executing attachment causes the first electronic apparatus to recognize the existence of the device (data transfer control system, and electronic apparatus including this), and send a reset signal to the first bus. Thereby, power supply to the device is turned on. Therefore, when the electronic apparatus is coupled via the first bus to the first electronic apparatus, power supply to the device is not turned on immediately after the coupling, achieving power supply control that provides high efficiency of power saving.

In the aspect of the invention, the coupling control unit may issue an instruction to execute detachment from the first bus if a reset state of the first bus is detected after attachment. Also, the power supply control unit may implement power supply control to turn on power supply to the device after detachment. Furthermore, the coupling control unit may issue an instruction to execute attachment to the first bus after power supply is turned on.

This operation sequence allows power supply to the device to be turned on after detachment is executed and thus the device (data transfer control system and electronic apparatus) is removed from the first electronic apparatus. Then, attachment is executed-after power supply is turned on, causing the first electronic apparatus to recognize the device (data transfer control system and electronic apparatus). Thus, malfunction can be prevented.

Also, in the aspect of the invention, the power supply control unit may implement power supply control to keep power supply to the device off if a reset state of the first bus is not detected after attachment and a suspend state of the first bus is detected.

This power supply control keeps power supply to the device off if the first electronic apparatus is in a standby state or the like and the first bus is in a suspend state, leading to power saving.

In addition, in the aspect of the invention, first data transfer processing between the first electronic apparatus and the device may be switched to second data transfer processing between a second electronic apparatus and the device, if a third bus coupled to the second electronic apparatus enters an active state when power feed to a power supply line of the first bus is in an off state.

This operation can achieve control of switching from the first data transfer processing to the second data transfer processing with simple determination processing, and thus allows the first and second electronic apparatuses to share the device.

Furthermore, in the aspect of the invention, the power supply control unit may implement power supply control to turn off or save power supply to the device if an off state of power feed to the power supply line of the first bus is detected.

Also, in the aspect of the invention, first data transfer processing between the first electronic apparatus and the device may be switched to second data transfer processing between a second electronic apparatus and the device, if a third bus coupled to the second electronic apparatus enters an active state when the first bus is in a suspend state.

This operation can achieve control of switching from the first data transfer processing to the second data transfer processing with simple determination processing, and thus allows the first and second electronic apparatuses to share the device.

In addition, in the aspect of the invention, the first data transfer processing may be switched to the second data transfer processing if a suspend state of the first bus is not released after elapse of a certain period after detection of the suspend state, and the third bus enters an active state.

According to this operation, the first data transfer processing is not switched to the second data transfer processing if the first bus temporarily enters a suspend state. Therefore, the stability and reliability of the system can be enhanced.

Furthermore, the power supply control unit may implement power supply control to turn off or save power supply to the device if a suspend state of the first bus is not released after elapse of a certain period after detection of the suspend state.

Another aspect of the invention relates to an electronic apparatus that includes the data transfer control system according to the aspect of the invention and a device coupled to a second bus.

The electronic apparatus according to the aspect may further include a power supply switch that switches a power supply of the electronic apparatus on and off, a power supply circuit that supplies power if the power supply switch is switched on, and a switch circuit that receives, from the data transfer control system, a power supply control signal for controlling power supply to the device. The switch circuit supplies power from the power supply circuit if the power supply control signal is active, and the switch circuit turns off or saves supply of power from the power supply circuit to the device if the power supply control signal is non-active.

Another aspect of the invention relates to a program for controlling data transfer between a first electronic apparatus coupled to a first bus and a device coupled to a second bus. The program causes a computer to execute processing including issuing an instruction to execute attachment to the first bus before power supply to the device is turned on, detecting whether or not the first bus enters a reset state after attachment, and implementing power supply control to turn on power supply to the device if a reset state of the first bus is detected.

### BRIEF DESCRIPTION OF THE DRAWINGS

The invention will be described with reference to the accompanying drawings, wherein like numbers refer to like elements, and wherein:

FIGS. 1A and 1B are explanatory diagrams for a power supply link method;

FIG. 2 is a flowchart for illustrating an example of processing of a power supply link method;

FIG. 3 is a diagram illustrating an example of the configuration of a data transfer control system and an electronic apparatus of an embodiment of the invention;

FIG. 4 is a diagram illustrating another example of the configuration of data transfer control systems and an electronic apparatus of the embodiment of the invention;

FIGS. 5A to 5C are explanatory diagrams for a method according to the embodiment;

FIGS. 6A to 6C are explanatory diagrams for the method according to the embodiment;

FIGS. 7A and 7B are explanatory diagrams for a method according to the embodiment;

FIG. 8 is a flowchart for illustrating processing of the embodiment; and

FIG. 9 is a flowchart for illustrating processing of the embodiment.

### DESCRIPTION OF THE EMBODIMENTS

An embodiment of the invention will be described below in detail. It should be noted that the following embodiment does not limit the scope of the invention set forth in claims. In addition, all components employed in the embodiment are not necessarily essential to achieve the advantage of the invention.

1. Power Supply Link Function

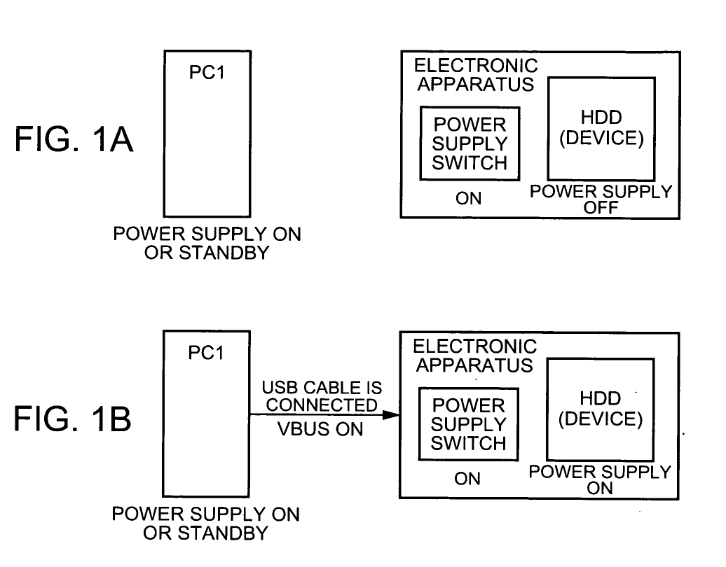

Referring to FIG. 1A, an electronic apparatus has a device such as a hard disk drive (HDD). Some of such electronic apparatuses have a power supply link function. Specifically, a power supply of the HDD is kept off when merely a power supply switch of the electronic apparatus is turned on. The power supply of the HDD is turned on, on condition that the electronic apparatus is coupled via a universal serial bus (USB) cable to a personal computer PC1 as shown in FIG. 1B.

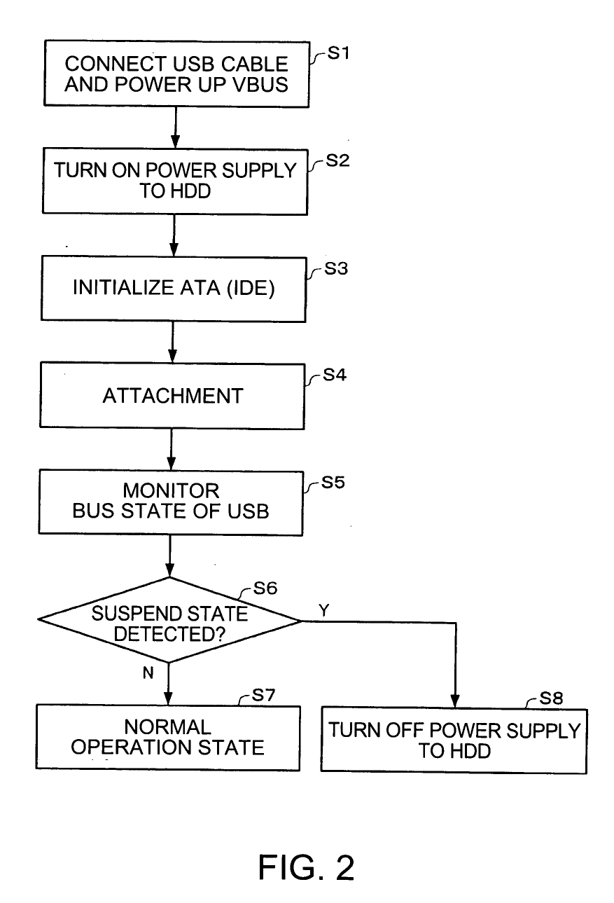

More specifically, referring to FIG. 2, when the USB cable is connected to the personal computer and VBUS (VBUS power feed) is powered up (step S1), power supply to the HDD is turned on (step S2). ATA (IDE) connected to the HDD is initialized (step S3), and then attachment to the USB is carried out (step S4). Subsequently, the bus state of the USB is monitored (step S5). If a suspend state is not detected (step S6: N), the operation state moves to a normal operation state (step S7). If a suspend state is detected (step S6: Y), power supply to the HDD is turned off (step S8).

In the power supply link method of FIG. 2, however, power supply to the HDD is turned on even when the electronic apparatus is coupled to PC1 in a standby state. It is not until the suspend state of the USB is detected after processing of the steps S3 to S6 of FIG. 2 that power supply to the HDD is turned off in the step S8. Therefore, power is problematically consumed at the HDD wastefully during the period of the processing of the steps S3 to S6 of FIG. 2, during which the HDD is not used actually.

2. Entire Configuration

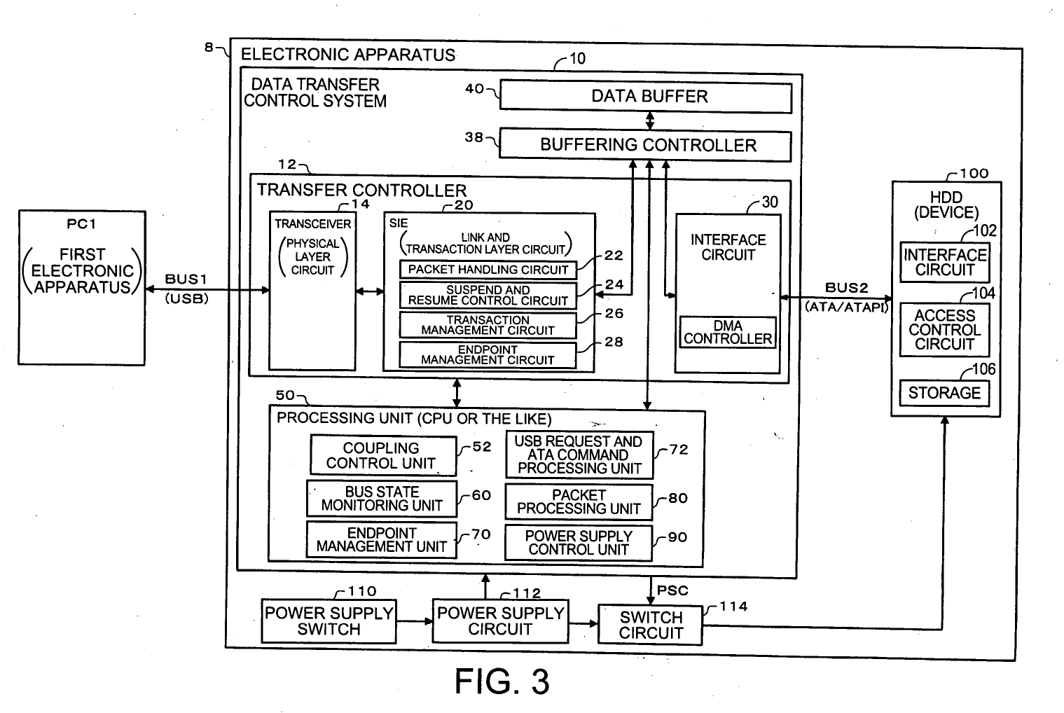

FIG. 3 illustrates an example of the configuration of a data transfer control system and an electronic apparatus including the data transfer control system according to the embodiment for addressing and solving the above-described problem. The invention is not limited the following example in which a device in the electronic apparatus is a HDD. For example, a device in the electronic apparatus may be a storage device other than a HDD, such as an optical disk drive or magnetooptical disk drive, or may be a device other than a storage device. Also, the invention is not limited to the following example in which a first electronic apparatus coupled to the electronic apparatus via BUS1 is a personal computer (PC). For example, the first electronic apparatus may be an electronic apparatus other than a PC, such as a portable information processing terminal or cellular phone. In addition, BUS 1 may be a high-speed serial bus other than USB 1.1 and USB 2.0, including a multi-channel serial bus. Alternatively, part or all of BUS 1 may be a wireless bus.

The personal computer PC1 (first electronic apparatus or first host system, in a broader sense) is coupled to an electronic apparatus 8 via BUS1 (first bus or first serial bus) compliant with USB (USB 1.1, USB 2.0 or the like).

The electronic apparatus 8 includes a data transfer control system 10 and a device 100. The electronic apparatus 8 also includes a power supply switch 110 to switch a power supply of the electronic apparatus 8 (data transfer control system 10) on and off, and a power supply circuit 112 to supply power when the power supply switch 100 is turned on. The electronic apparatus 8 further includes a switch circuit 114 to switch on and off power supply from the power supply circuit 112 to the HDD 100 based on a power supply control signal PSC from the data transfer control system 10. Although FIG. 3 illustrates only one HDD, which is a logical unit, two or more logical units may be included. The electronic apparatus 8 may further include, a system CPU, system memories (ROM and RAM), an operation unit, a display unit, a signal processing device that are not shown in the diagram.

The data transfer control system 10 includes a transfer controller 12, a buffering controller 38, a data buffer 40, and a processing unit 50. Part of these units may be omitted. For example, the buffering controller 38 and the data buffer 40 may be omitted.

The transfer controller 12 controls data transfer between PC1 (first electronic apparatus) coupled to BUS1 and the HDD 100 (device) coupled to BUS2.

The buffering controller 38 controls access (write/read access) to the data buffer 40 that temporarily stores transferred data. The buffering controller 38 may include a pointer management unit to manage plural pointers for writing and reading, a register to control the buffering controller 38, an arbitration circuit to arbitrate bus-connection to the data buffer 40, a sequencer to generate various control signals, and so on.

The data buffer 40 (packet buffer, or FIFO memory) is a buffer (memory) to temporarily store transferred data (packet), and can be made up of hard ware such as an SRAM, SDRAM or DRAM. The data buffer 40 may be externally attached to the data transfer control system 10 instead of being incorporated in the control system 10.

The transfer controller 12 includes a transceiver 14, an serial interface engine (SIE) 20 and an interface circuit 30. The transfer controller 12 does not need to include all circuit blocks shown in FIG. 3. Part of the blocks may be omitted. For example, the transceiver 14 may not be included.

The transceiver 14 is a circuit to transmit and receive data by using differential data lines DP and DM (differential data signals). The transceiver 14 includes, for example, a USB physical layer circuit (analogue front end circuit). If BUS1 is USB 2.0, a macro block compliant with the USB 2.0 transceiver macrocell interface (UTMI) specification of USB 2.0 can be used for the transceiver 14. The transceiver 14 may include a circuit of a layer other than a physical layer.

The SIE 20 (link and transaction layer circuit) is a circuit for USB packet transfer processing. The SIE 20 includes a packet handling circuit 22, a suspend and resume control circuit 24, a transaction management circuit 26, and an endpoint management circuit 28. Part of these circuits may be omitted.

The packet handling circuit 22 assembles (creates) and disassembles packets composed of a header and data, and creates and decodes CRC. The suspend and resume control circuit 24 implements sequence control at the time of suspend or resume. The transaction management circuit 26 manages transactions that are sequences of packets such as token, data and handshake packets. The endpoint management circuit 28 manages endpoints serving as a gateway to each storage area of the data buffer 40, and includes a register (register set) to store attribute information of the endpoints, and so on.

The interface circuit 30 implements processing of interface to the HDD 100 (device, in a broader device). The function of the interface circuit 30 allows data transfer to and from the HDD 100 via BUS2, compliant with AT attachment (ATA) and ATA packet interface (ATAPI).

The provision of the transceiver 14, the SIE 20, the interface circuit 30 and so on enables the data transfer control system 10 to have the function of a bridge between USB (first interface standard, in a broader sense) and ATA (IDE)/ATAPI (second interface standard, in a broader sense).

A DMA controller 32 in the interface circuit 30 is a circuit to implement direct memory access (DMA) transfer to and from the HDD 100 via BUS2. The HDD 100 coupled to BUS2 includes an interface circuit 102 for data transfer compliant with ATA (IDE)/ATAPI, an access control circuit 104 for controlling access (read/write) to a storage 106, and the storage 106 such as a hard disk.

The processing unit 50 controls data transfer and the entire apparatus. The processing unit 50 includes a coupling control unit 52, a bus state monitoring unit 60, an endpoint management unit 70, a USB request and ATA command processing unit 72, a packet processing unit 80, and a power supply control unit 90. Part of these units may be omitted. Each unit in the processing unit 50 can be implemented with a hardware circuit such as a CPU (processor) and a program (firmware) operating on the CPU. The program (processing module) can be stored in a non-volatile memory (EEPROM), in which data can be rewritten electrically, or a memory such as a ROM. Note that part or all of these units in the processing unit 50 may be implemented with a dedicated hardware circuit (ASIC).

The coupling control unit 52 controls coupling to BUS1 (USB). Specifically, the coupling control unit 52 issues an instruction to execute attachment or detachment to or from BUS1 (PC1). More specifically, when executing attachment or detachment, the coupling control unit 52 writes, to a register, information issuing an instruction to execute attachment or detachment.

Attachment is operation for causing PC1 or the like coupled to BUS1 to recognize the existence of the electronic apparatus 8 (HDD 100). Detachment is removal operation to stop the recognition. Executing the attachment allows an operating system (OS) on PC1 to recognize that the electronic apparatus 8 is coupled to BUS1 (USB). In contrast, executing the detachment removes the electronic apparatus 8 from BUS1, precluding the OS from recognizing the existence of the electronic apparatus 8.

The bus state monitoring unit 60 implements processing to monitor the bus state of BUS 1 (USB). Specifically, the monitoring unit 60 detects a reset state, a suspend state and so forth of BUS1 by monitoring the bus state of BUS1. The monitoring unit 60 also implements processing to detect whether VBUS (power supply line, in a broader sense) is on or off (power feed is on or off).

When a USB cable is connected to the apparatus and VBUS is powered up, the data transfer control system 10 (electronic apparatus 8) executes attachment to BUS1 based on an instruction from the coupling control unit 52. Specifically, the voltage levels of the differential data lines DP (D+) and DM (D−) of BUS1 are raised. Then, PC1 detects the attachment. For example, the attachment is detected if the voltage of either DP or DM is raised to 3.3 V or more. When the attachment is detected, PC1 sends a reset signal to BUS1 continuously for a certain period (for example, 10 msec) or longer. Specifically, PC1 sends the reset signal by setting both DP and DM to a low level, for example.

When PC1 sends the reset signal, the bus state monitoring unit 60 detects the reset state of BUS1. Then, the data transfer control system 10 is internally reset, and thus enters a default state. Subsequently, control transfer is implemented using an endpoint 0 (pipe 0), and configuration is implemented. Specifically, device descriptor information of the electronic apparatus 8 (HDD 100) is sent to PC1, allowing packet transfer via BUSI.

The endpoint management unit 70 implements processing to manage endpoints. Specifically, the management unit 70 instructs the endpoint management circuit 28 to manage the endpoints. The USB request and ATA command processing unit 72 implements processing relating to a USB request sent from PC1 or the like via BUS1. The processing unit 72 also implements processing relating to an ATA command issued to the HDD 100. The packet processing unit 80 implements processing to analyze packets transferred via BUS1 and processing to respond to the packets. The processing at the USB request and ATA command processing unit 72 and the packet processing unit 80 allows data transfer between PC1 (first electronic apparatus) coupled to BUS1 and the HDD (device) coupled to BUS2.

The power supply control unit 90 implements various kinds of control relating to power supply to the HDD 100 and the data transfer control system 10.

As described above, in the present embodiment, the coupling control unit 52 issues an instruction to execute attachment to BUS1 before power supply to the HDD 100 (device) is turned on. Then, the transfer controller 12 (transceiver 14) raises the voltages of DP and DM to execute attachment to BUS1 (PC1). After the attachment, the bus state monitoring unit 60 detects whether or not BUS1 enters a reset state. If the reset state of BUS1 is detected, the power supply control unit 90 implements power supply control to turn on power supply to the HDD. Specifically, the control unit 90 activates the power supply control signal PSC for controlling power supply to the HDD 100. Then, the switch circuit 114 that has received the power supply control signal PSC supplies power from the power supply circuit 112 to the HDD 100. The above-described operation sequence can prevent a situation in which power supply to the HDD 100 is turned on when the electronic apparatus 8 is coupled to PC1 in a standby state. Specifically, in the present embodiment, a determination is made as to whether or not power supply to the HDD 100 should be turned on before the power supply is actually turned on. Therefore, wasteful power consumption at the HDD 100 can be prevented.

In addition, the following processing is implemented in the present embodiment. Specifically, if the bus state monitoring unit 60 detects the reset state of BUS 1 after attachment, the coupling control unit 52 issues an instruction to execute detachment from BUS1. Then, after the detachment, the power supply control unit 90 implements power supply control to turn on power supply to the HDD 100. Subsequently, the coupling control unit 52 issues an instruction to execute attachment to BUS1 after power supply is turned on. According to the above-described operation sequence, power supply to the HDD 100 is turned on while the HDD is 100 detached from the apparatus, preventing the occurrence of malfunction and so forth.

Note that in the present embodiment, if the reset state of BUS1 is not detected after attachment, a determination is made that the suspend state of BUS1 is detected, and therefore the power supply control unit 90 implements power supply control to keep power supply to the HDD 100 off. This power supply control prevents wasteful power consumption at the HDD 100 when BUS1 is in a suspend state (PC1 is in a standby state).

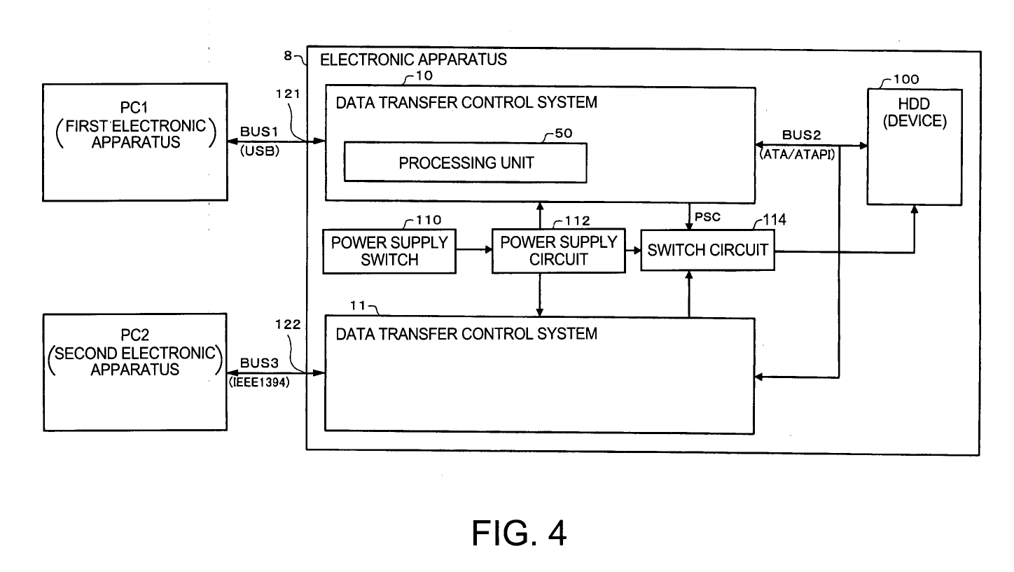

FIG. 4 illustrates another example of the configuration of data transfer control systems and an electronic apparatus of the present embodiment. Referring to FIG. 4, the electronic apparatus 8 includes a port 121 for the first bus BUS1 (USB) and a port 122 for a third bus BUS3 (IEEE1394). The data transfer control system 10 (first data transfer control IC) controls data transfer (first data transfer processing) between PC1 (first electronic apparatus) coupled to BUS1 (port 121) and the HDD 100 coupled to BUS2. Also, a data transfer control system 11 (second data transfer control IC) controls data transfer (second data transfer processing) between PC2 (second electronic apparatus) coupled to BUS3 (port 122) and the HDD 100 coupled to BUS2.

In the configuration of FIG. 4, PC2 can use the HDD1 to write and read data while PC1 does not use the HDD 100. Specifically, if BUS3 enters an active state (cable active) when VBUS (power supply line) of BUS1 is in an off state, data transfer processing is switched from the first data transfer processing between PC1 and the HDD 100 to the second data transfer processing between PC2 and the HDD 100. Also, if BUS3 enters an active state (cable active) when BUS1 is in a suspend state, data transfer is switched from the first data transfer processing between PC1 and the HDD 100 to the second data transfer processing between PC2 and the HDD 100.

3. Method of Embodiment

3.1 Power Supply Link Operation

In the power supply link method of FIGS. 1A and 1B, a power supply of a HDD is turned on even when an electronic apparatus is coupled to PC1 in a standby state. However, the HDD is not used by PC1 during the period when PC1 is in a standby state. Therefore, turning on the power supply of the HDD during the standby state of PC1 results in wasteful power consumption at the HDD.

In order to avoid this problem, in the present embodiment, attachment is first executed after coupling to BUS1 (USB) to determine whether or not BUS1 enters a reset state. Then, if a reset state is detected, power supply to the HDD 100 (device) is turned on.

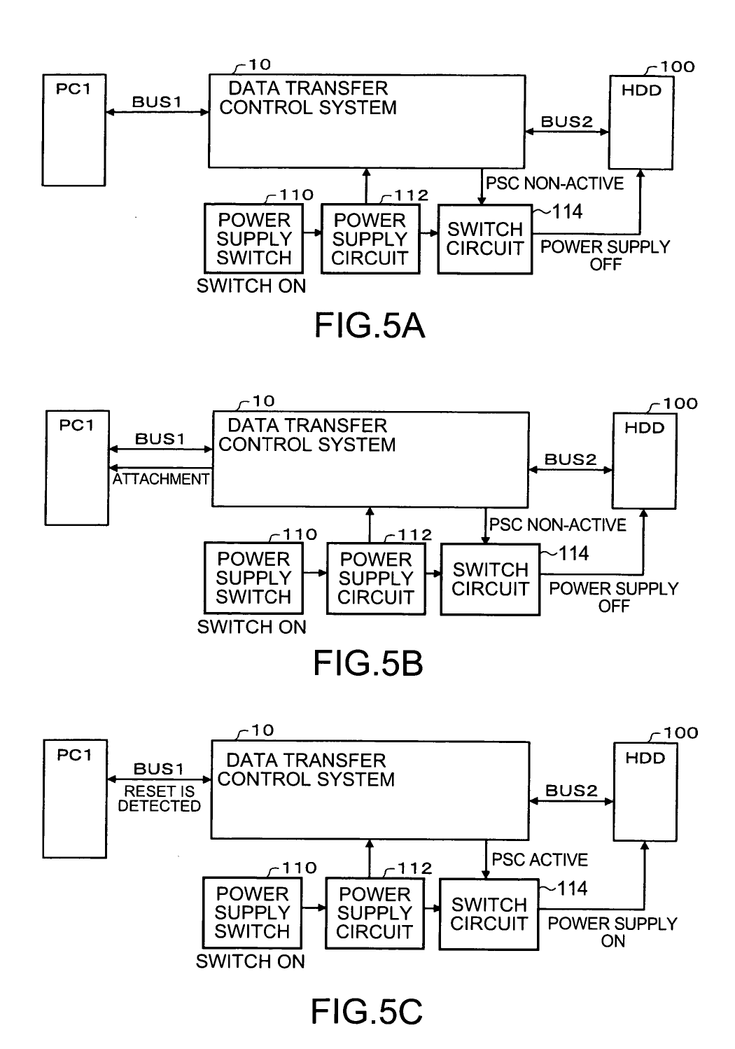

Specifically, referring to FIG. 5A, power supply to the HDD 100 is kept off even when the power supply switch 110 of the electronic apparatus is turned on. Specifically, the power supply control unit 90 sets the power supply control signal PSC to non-active, and the switch circuit 114 that has received the signal turns off power supply from the power supply circuit 112 to the HDD 100. Then, referring to FIG. 5B, operation of attachment to BUS1 (PC1) is implemented before power supply to the HDD 100 is turned on.

Subsequently, referring to FIG. 5C, the bus state of BUS1 is monitored to detect whether or not BUS1 enters a reset state (whether or not PC1 sends a reset signal). If the reset state of BUS1 is detected, the power supply of the HDD 100 is turned on. Specifically, the power supply control unit 90 sets the power supply control signal PSC to active, and the switch circuit 114 that has received the signal turns on power supply from the power supply circuit 112 to the HDD 100.

As described above, a determination is made as to whether or not the power supply of the HDD should be turned on before the power supply is actually turned on. Specifically, attachment operation, which is typically used to induce PC1 to recognize the existence of the HDD 100, is used for a determination as to whether or not the power supply of the HDD 100 should be turned on.

Thus, the power supply of the HDD 100 is kept off when the electronic apparatus is coupled to PC1 in a standby state (or off state). Specifically, if PC1 is in a standby state, PC1 does not send a reset signal even if the data transfer control system 10 implements attachment operation. Therefore, the reset state of BUS1 is not detected. In this case, a determination is made that BUS1 is in a suspend state, and the power supply of the HDD 100 is kept off. Thus, the power supply of the HDD 100 is kept off during the period when PC1 is in a standby state, preventing wasteful power consumption. Since the HDD 100 is not used by PC1 when PC1 is in a standby state, keeping off the power supply of the HDD 100 as described above causes no problem.

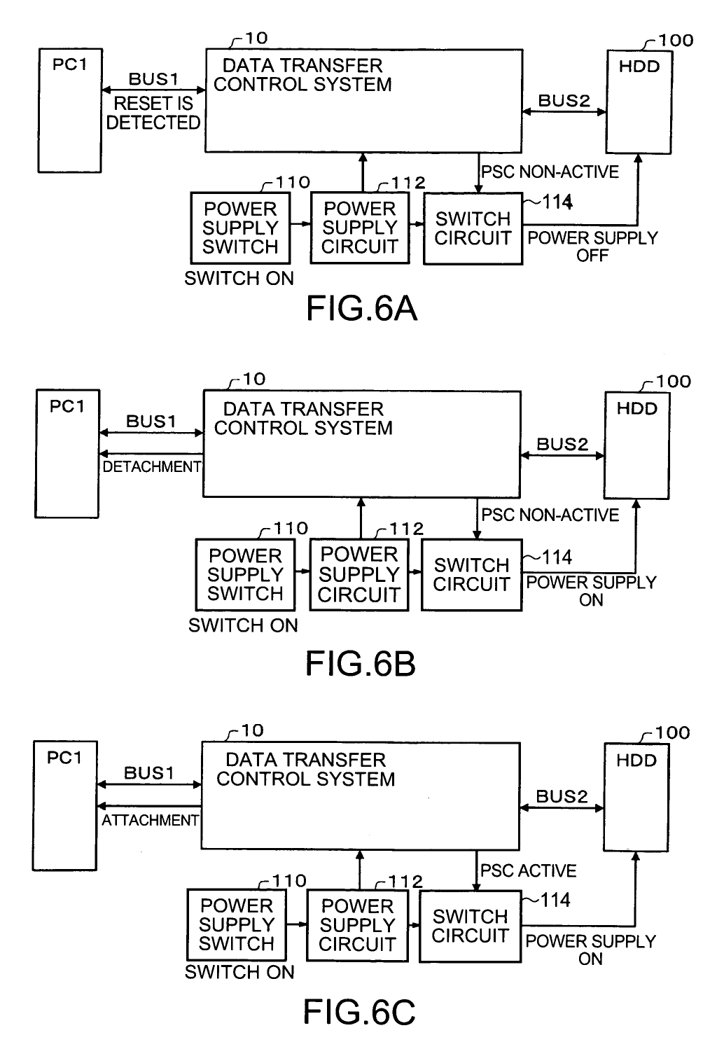

Also in the present embodiment, if the reset state of BUS1 is detected after attachment as shown in FIG. 6A, detachment from BUS1 (PC1) is executed as shown in FIG. 6B, and then power supply to the HDD 100 is turned on after the detachment. Referring next to FIG. 6C, attachment to BUS1 is executed after the power supply is turned on.

Executing detachment as shown in FIG. 6B precludes PC1 from recognizing the HDD 100. Therefore, a situation can be prevented in which PC1 accesses the HDD 100 during the period when the power supply of the HDD 100 is off, or during the transition period from off to on, for example, and thus malfunction and so on can be avoided. Also, since attachment is executed after the power supply of the HDD 100 is turned on as shown in FIG. 6C, PC1 can access the HDD 100 that has been adequately turned on, allowing improvement of the stability and reliability of the system.

3.2 Control of Switching Data Transfer Processing

The configuration of FIG. 4 permits both the first data transfer processing between PC1 and the HDD 100, and the second data transfer processing between PC2 and the HDD 100. The present embodiment achieves control of switching the first and second data transfer processing as follows.

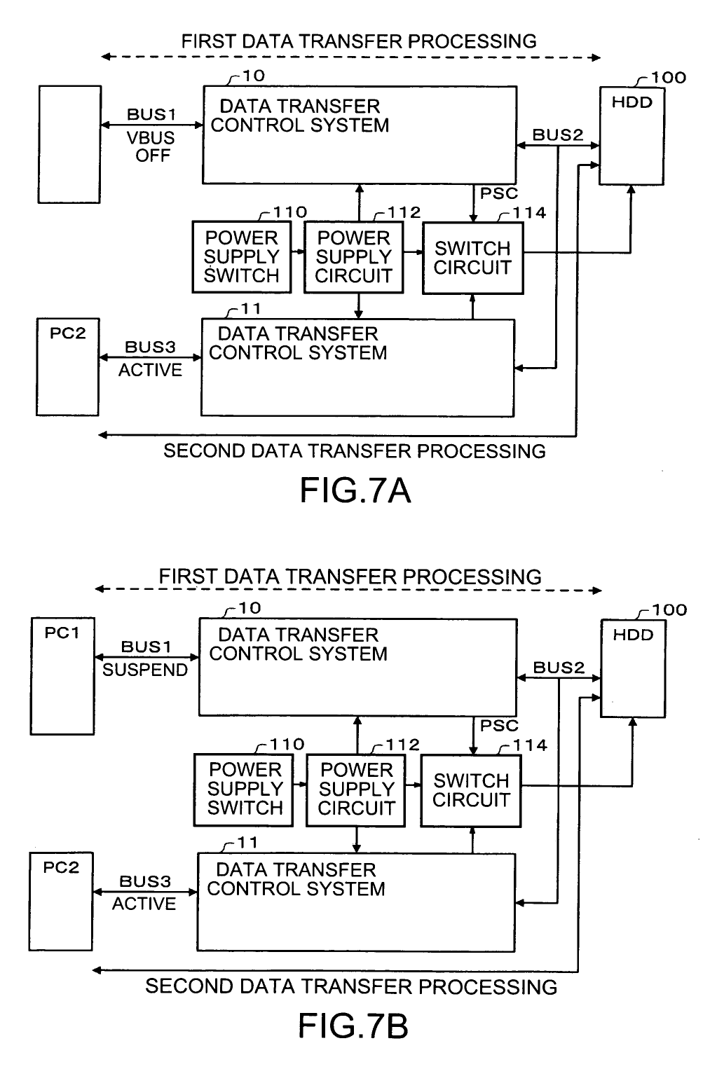

Specifically, referring to FIG. 7A, if BUS3 enters an active state (cable active) when VBUS (power supply line) of BUS1 (USB) is off (VBUS voltage is equal to or smaller than a certain voltage), data transfer processing is switched (shifted) from the first data transfer processing between PC1 and the HDD 100 to the second data transfer processing between PC2 and the HDD 100. Here, the active state is a state in which the cable of BUS3 is physically coupled while a bias voltage is supplied, and thus data transfer is possible.

Note that if the off state of VBUS (VBUS feed) is detected, power supply to the HDD 100 may be turned off (or may be saved). Then, after power supply to the HDD 100 is turned off, data transfer processing is switched from the first data transfer processing (USB processing) to the second data transfer processing (IEEE1394 processing). This operation sequence can achieve power supply control with higher efficiency of power saving.

Furthermore in the present embodiment, referring to FIG. 7B, if BUS3 (IEEE1394) enters an active state (cable active) when BUS1 (USB) is in a suspend state, data transfer processing is switched from the first data transfer processing between PC1 and the HDD 100 to the second data transfer processing between PC2 and the HDD 100.

In this case, if the suspend state of BUS1 is not released even after the elapse of a certain period (for example, one second) after the detection of the suspend state, and BUS2 enters an active state, the first data transfer processing is switched to the second data transfer processing. Thus, a situation can be prevented in which the first data transfer processing is switched to the second data transfer processing while BUS1 is temporarily in a suspend state. Therefore, the stability and reliability of switch processing can be enhanced.

In addition, power supply to the HDD 100 may be turned off (or may be saved) if the suspend state of BUS1 is not released even after the elapse of a certain period (for example, one second) after the detection of the suspend state. This operation sequence can achieve power supply control with higher efficiency of power saving.

Switching data transfer processing (data transfer path) by the above-described method enables PC1 and PC2 to share the HDD 100, improving convenience of users. Furthermore, only by detecting whether or not VBUS of BUSI is in an on state, whether or not BUSi is in a suspend state, and whether or not BUS3 is in an active state, a determination as to switching data transfer processing can be made, and thus switch control can be simplified.

4. Detailed Processing

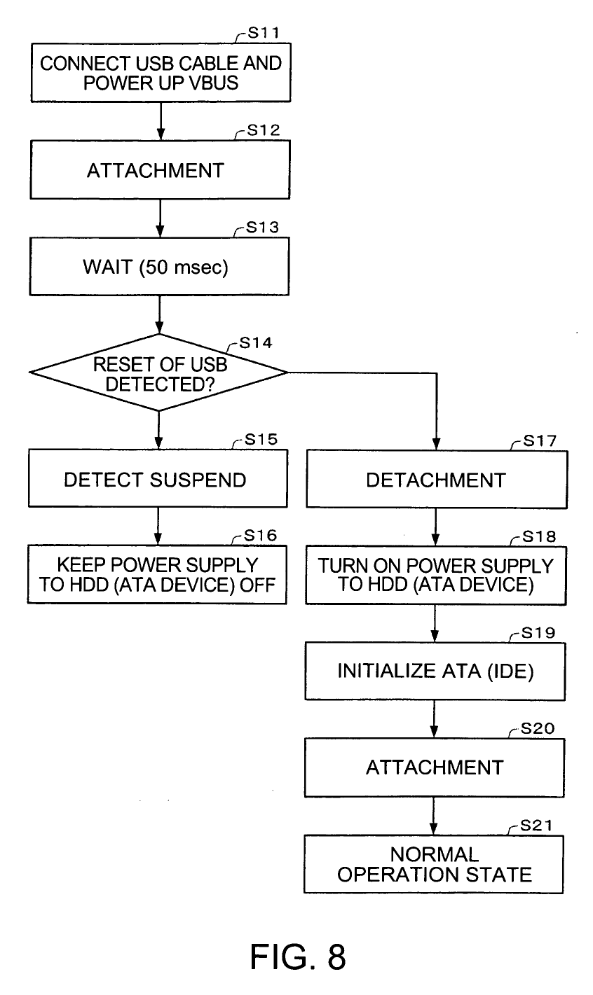

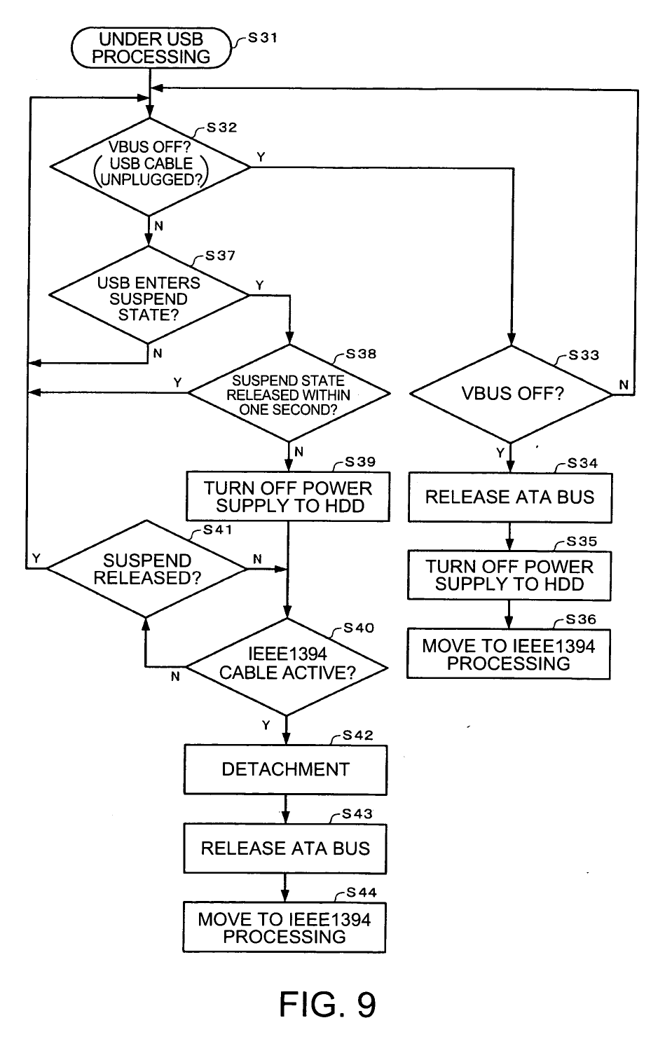

An example of detailed processing sequence of the method of the present embodiment will now be described below with reference to flowcharts of FIGS. 8 and 9.

FIG. 8 illustrates a flowchart relating to control of power supply to a HDD. When a USB cable is connected and VBUS is powered up (step S1), attachment operation is executed as described referring to FIG. 5B (step S12). Then, waiting is carried out for a certain period (for example, 50 msec) (step S13).

Subsequently, whether or not the reset state of USB is detected (step S14). If the reset state is not detected (S14: N), a determination is made that USB is in a suspend state (step S15). Then, power supply to the HDD (ATA device) is kept off (step S16). Specifically, the power supply control signal PSC is kept non-active.

In contrast, if the reset state of USB is detected in the step S14 (S14: Y), detachment operation is executed as described referring to FIG. 6B (step S17), and thereafter power supply to the HDD (ATA device) is turned on (step S18). Then, initialization processing for ATA (IDE) is executed (step S19). Subsequently, attachment operation is executed as described referring to FIG. 6C (step S20), and then the operation state moves to a normal operation state (step S21).

FIG. 9 illustrates a flowchart relating to control of switching from USB processing (first data transfer processing) to IEEE1394 processing (second data transfer processing).

Under USB processing (step S31), whether or not VBUS is turned off (whether or not a USB cable is unplugged) is detected (step S32). If the off state of VBUS is detected (S32: Y), whether or not VBUS is in the off state is rechecked (step S33). If the off state of VBUS is reconfirmed (S33: Y), the ATA bus (BUS2) is released (step S34). Specifically, PC2 is allowed to use the ATA bus. Subsequently, power supply to the HDD is turned off (step S35), and then processing moves (jumps) to IEEE processing (step S36).

If the off state of VBUS is not detected in the step S32 (S32: N), whether or not USB enters a suspend state is detected (step S37). If the suspend state is not detected (S37: N), the sequence returns to the step S32. In contrast, if the suspend state is detected (S37: Y), whether or not the suspend state is released within one second (a certain period) is detected (step S38). If the suspend state is released (S38: Y), the sequence returns to the step S32, while if the suspend state is not released (S38: N), power supply to the HDD is turned off (step S39).

Subsequently, whether or not IEEE1394 is cable active (in an active state) is detected (step S40). If IEEE1394 is not cable active (S40: N), whether or not the suspend state is released is detected (step S41). Then, if release of the suspend state is detected (S41: Y), the sequence returns to the step S32. In contrast, if cable active of IEEE 1394 is detected (S40: Y), detachment operation is executed (step S42), and then the ATA bus (BUS2) is released (step S43). Specifically, PC2 is allowed to use the ATA bus. Then, processing moves to IEEE1394 processing (step S44).

The invention is not limited to the embodiment, and various modifications can be made within the gist of the invention. For example, the terms (PC1, PC2, HDD, VBUS, USB, ATA/ATAPI and so forth), which are used as alternatives of the terms of a broader sense or synonymous terms (first electronic apparatus, second electronic apparatus, device, power supply line, first interface standard, second interface standard and so forth, respectively) in some descriptions in the specification or drawings, may also be replaced by the terms of a broader sense or synonymous terms in other descriptions in the specification or drawings.

In addition, the configuration of the data transfer control system and the electronic apparatus of the invention is not limited to the configuration shown in FIGS. 3 and 4, and various modifications can be made. For example, part of the blocks in FIGS. 3 and 4 may be omitted, or the coupling relationship among the blocks may be changed. Also, the device coupled to the second bus (BUS2) is not limited to a storage device such as a HDD. Furthermore, the coupling configuration among the transceiver, SIE and data buffer is not limited to the coupling configuration shown in FIG. 3.

In addition, although the embodiment shows the case in which the coupling control unit, bus state monitoring unit, power supply control unit and so forth are implemented with firmware (program), part or all of the functions of these units may be implemented with hardware circuits.

The invention can be applied to various electronic apparatuses, such as a hard disk drive, optical disk drive, magnetooptical disk drive, portable information terminal, PDA, expansion apparatus, audio apparatus, digital video camera, cellular phone, printer, scanner, TV set, VTR, telephone set, display, projector, personal computer, and electronic notebook.

Also, the embodiment has shown the case in which the invention is applied to data transfer compliant with the USB 1.1 or USB 2.0 standard. The invention, however, can also be applied to data transfer or the like compliant with, for example, a standard base on the similar idea as that of these standards, or a standard resulting from development of these standards.

What is claimed is:

1. A data transfer control system for controlling data transfer between a first electronic apparatus coupled to a first bus and a device coupled to a second bus, comprising:
a coupling control unit that issues an instruction to execute attachment to the first bus before power supply to the device is turned on;
a bus state monitoring unit that detects whether or not the first bus enters a reset state after attachment; and
a power supply control unit that implements power supply control to turn on power supply to the device if a reset state of the first bus is detected.

2. The data transfer control system according to claim 1, wherein the coupling control unit issues an instruction to execute detachment from the first bus if a reset state of the first bus is detected after attachment, the power supply control unit implementing power supply control to turn on power supply to the device after detachment, the coupling control unit issuing an instruction to execute attachment to the first bus after power supply is turned on.

3. The data transfer control system according to claim 1, wherein the power supply control unit implements power supply control to keep power supply to the device off if a reset state of the first bus is not detected after attachment and a suspend state of the first bus is detected.

4. The data transfer control system according to claim 1, wherein first data transfer processing between the first electronic apparatus and the device is switched to second data transfer processing between a second electronic apparatus and the device, if a third bus coupled to the second electronic apparatus enters an active state when power feed to a power supply line of the first bus is in an off state.

5. The data transfer control system according to claim 4, wherein the power supply control unit implements power supply control to turn off or save power supply to the device if an off state of power feed to the power supply line of the first bus is detected.

6. The data transfer control system according to claim 1, wherein first data transfer processing between the first electronic apparatus and the device is switched to second data transfer processing between a second electronic apparatus and the device, if a third bus coupled to the second electronic apparatus enters an active state when the first bus is in a suspend state.

7. The data transfer control system according to claim 6, wherein the first data transfer processing is switched to the second data transfer processing if a suspend state of the first bus is not released after elapse of a certain period after detection of the suspend state, and the third bus enters an active state.

8. The data transfer control system according to claim 6, wherein the power supply control unit implements power supply control to turn off or save power supply to the device if a suspend state of the first bus is not released after elapse of a certain period after detection of the suspend state.

9. An electronic apparatus comprising:
the data transfer control system according to claim 1; and
the device coupled to the second bus.

10. The electronic apparatus according to claim 9, further comprising:
a power supply switch that switches a power supply of the electronic apparatus on and off;
a power supply circuit that supplies power if the power supply switch is turned on; and
a switch circuit that receives, from the data transfer control system, a power supply control signal for controlling power supply to the device, the switch circuit supplying power from the power supply circuit if the power supply control signal is active, the switch circuit turning off or saving supply of power from the power supply circuit to the device if the power supply control signal is non-active.

11. A program for controlling data transfer between a first electronic apparatus coupled to a first bus and a device coupled to a second bus, the program causing a computer to execute processing comprising:
issuing an instruction to execute attachment to the first bus before power supply to the device is turned on;
detecting whether or not the first bus enters a reset state after attachment; and
implementing power supply control to turn on power supply to the device if a reset state of the first bus is detected.
